(19) United States
(12) Patent Application Publication
(10) Pub. No.: US 2024/0101769 A1
(43) Pub. Date: Mar. 28, 2024

(54) THERMOFORMABLE POLYMERIC SHEETS BASED ON PSEUDO-AMORPHOUS POLYARYLETHER KETONE

(71) Applicant: Arkema France, Colombes (FR)

(72) Inventors: Roderick REBER, III, King of Prussia, PA (US); Jason LYONS, King of Prussia, PA (US); Julien JOUANNEAU, Pierre-Benite Cedex (FR); Bruce CLAY, Boyertown, PA (US)

(73) Assignee: Arkema France, Colombes (FR)

(21) Appl. No.: 17/768,004

(22) PCT Filed: Oct. 14, 2020
(86) PCT No.: PCT/EP2020/078891

§ 371 Date: Apr. 11, 2022

Related U.S. Application Data
(60) Provisional application No. 62/915,096, filed on Oct. 15, 2019.

(51) Int. Cl. C08J 5/18; B29C 51/00; B29C 51/08

(52) U.S. Cl. CPC C08J 5/18; B29C 51/002; B29C 51/08; C08J 2471/12

(57) ABSTRACT

Sheets having thicknesses of from 1000 to 10,000 microns which are useful for the production of thermoformed semi-crystalline articles are based on polyaryletherketones having viscosities at 360° C. of at least about 400 Pas at 100 s⁻¹ as measured by parallel plate rheometer. The polyaryletherketones are in a pseudo-amorphous state in the thermoformable sheets.

### FIELD OF THE INVENTION

The invention pertains to polymeric sheets suitable for use in thermoforming applications, wherein the polymeric sheets are based on pseudo-amorphous polyaryletherketone (PAEK) polymers having certain melt viscosity attributes.

### BACKGROUND OF THE RELATED ART

High temperature thermoplastic polymers, such as polyaryletherketones (PAEKs), are continuously being evaluated as options in a multitude of applications, including those in the aerospace and integrated circuit industries. In general, PAEKs feature exceptional characteristics, including high-temperature and chemical resistance, very good mechanical properties, excellent abrasion resistance, and natural flame retardancy. PAEK parts may be produced by a multitude of processes, including thermoforming processes. PAEK parts formed by traditional thermoforming processes, however, may not demonstrate a desired resistance to deformation at elevated temperatures, among other properties.

The process of thermoforming is a routine manufacturing method. In traditional thermoforming, a plastic sheet is heated to a high temperature and placed in contact with a cold (or room temperature) mold to form a desired shape. When a pseudo-amorphous sheet is thermoformed by such traditional thermoforming methods, the thermoformed part is rapidly cooled and, thus, is also amorphous and retains the properties of the amorphous sheet subjected to thermoforming. In certain applications, however, it would be desirable to form a semi-crystalline part having the shape of the desired mold. A need has remained for thermoforming processes that can produce a semi-crystalline part from a pseudo-amorphous sheet thus producing a molded part that exhibits increased thermal resistance, improved chemical resistance, and improve mechanical properties in comparison to a pseudo-amorphous part formed by conventional thermoforming processes.

WO 2018/232119, the entire disclosure of which is incorporated herein by reference for all purposes, describes such a method. The method comprises the steps of:
as a softening step, heating a sheet comprised of at least one pseudo-amorphous polymer to a temperature above the glass transition temperature of the pseudo-amorphous polymer to soften the pseudo-amorphous polymer;
as a crystallization step, heating the sheet comprised of pseudo-amorphous polymer to a temperature above the glass transition temperature of the pseudo-amorphous polymer and below the melting temperature of the pseudo-amorphous polymer for a time sufficient to allow the pseudo-amorphous polymer to crystallize;
placing the sheet comprised of pseudo-amorphous polymer on a mold during either the softening step or the crystallization step before the crystallization takes place; and
forming an semi-crystalline molded article,
wherein the pseudo-amorphous polymer is a polyaryletherketone (PAEK) selected from the group consisting of polyetherketoneketone (PEKK), polyetherketone (PEK), polyetherketoneetherketoneketone (PEKEKK), and mixtures thereof.

Thermoformable polyaryletherketone sheets in which the polyaryletherketone is amorphous or only slightly crystalline (not more than 5 wt % crystallinity) are known in the art, as exemplified by the disclosure of U.S. Pat. No. 4,996,287. However, the procedures described in U.S. Pat. No. 4,996,287 for the preparation of such PAEK sheets have significant limitations. Notably, the patent teaches that when the T:I ratio of a PEKK used to prepare such a sheet is relatively high (e.g., 70:30 or 80:20), the maximum sheet thickness that can be achieved is only 625 microns (see Table 1). Thus, prior to the present invention, neither pseudo-amorphous PEKK sheets having both a high thickness (e.g., at least 1000 microns) and a high T:I ratio nor methods for obtaining such sheets were known. However, because the properties of a thermoformed PEKK sheet are significantly affected by both the sheet thickness and the T:I ratio, it would be highly desirable to develop methods and compositions capable of producing comparatively thick, thermoformable pseudo-amorphous sheets comprised of PEKK having a high T:I ratio (e.g., 70:30).

### SUMMARY OF THE INVENTION

One aspect of the present invention provides a sheet comprised of a polymer, wherein the sheet has a thickness of from about 1000 microns to about 10,000 microns (e.g. from 1000 microns to 10,000 microns) and the polymer is a polyaryletherketone (PAEK) in a pseudo-amorphous state which has a viscosity at 360° C. of at least about 400 Pa·s (e.g., at least 400 Pa·s) at 100 s⁻¹ as measured by parallel plate rheometer. It has now been discovered that the use of a PAEK meeting such viscosity requirements (i.e., a viscosity at 360° C. of at least about 400 Pa·s at 100 s⁻¹ as measured by parallel plate rheometer) is key to being able to extrude a comparatively thick polymeric sheet comprised of PAEK that is pseudo-amorphous in character and thus suitable for use in a thermoforming process involving a mold, to produce a semi-crystalline molded article. Having the polyaryletherketone in a pseudo-amorphous state in a sheet intended for thermoforming is desirable, as higher crystallinity PAEK sheets tend to be too stiff to be readily used in the molding step of a thermoforming process.

A further aspect of the invention provides a method of manufacturing a semi-crystalline article by thermoforming a sheet in accordance with the above description using a mold. Such method may comprise steps of:
a) as a softening step, heating a sheet in accordance with the above description to a temperature above the glass transition temperature of the polymer to soften the polymer;
b) as a crystallization step, heating the sheet to a temperature above the glass transition temperature of the polymer and below the melting temperature of the polymer for a time sufficient to allow the polymer to crystallize;
c) placing the sheet on a mold during either the softening step or the crystallization step before crystallization takes place; and
d) forming a semi-crystalline molded article.

The semi-crystalline article thus obtained may exhibit less than about 5%, less than about 4%, less than about 3%, less than about 2% or less than about 1% dimensional change compared to the mold.

Also provided by the present invention is a method of making a sheet comprised of a polymer, wherein the sheet has a thickness of from about 1000 microns to about 10,000 microns (e.g., from 1000 microns to 10,000 microns) and the polymer is a polyaryletherketone (PAEK) in a pseudo-amorphous state which has a viscosity at 360° C. of at least about 400 Pa·s (or at least 400 Pa·s) at 100 s⁻¹ as measured by parallel plate rheometer, wherein the method comprises:
a) heating a resin composition comprised of the polymer to a suitable processing temperature above the melting point of the polymer to provide a molten resin composition;
b) forming the molten resin composition into a sheet (for example, by melt extrusion through an appropriately sized die); and
c) quenching the sheet at a rate effective to obtain the polymer in a pseudo-amorphous state.

### BRIEF DESCRIPTION OF THE DRAWINGS

FIG. 1 shows the WAXD diffraction pattern of a PEKK sheet after extrusion, in accordance with the invention.

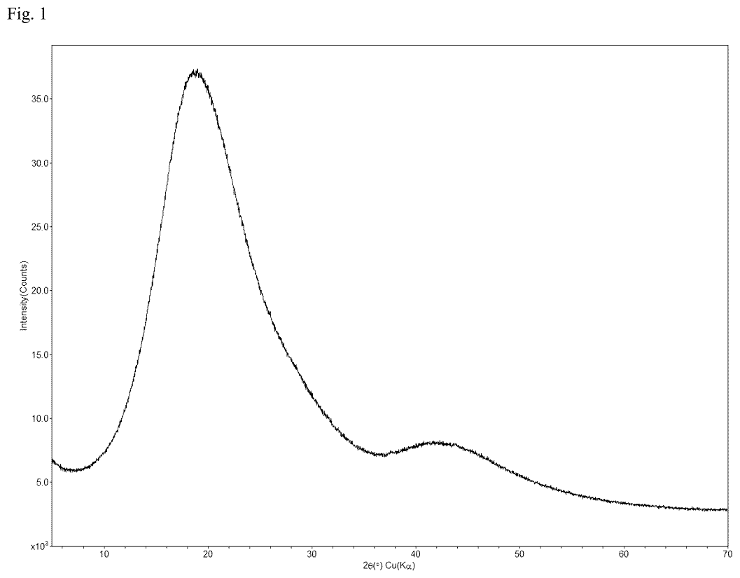

FIG. 2 shows the WAXD diffraction pattern of a PEKK sheet after thermoforming in accordance with one aspect of the invention. Peaks having a star “*” on top represent PEKK crystal form II, whereas peaks not having the star represent PEKK crystal form I.

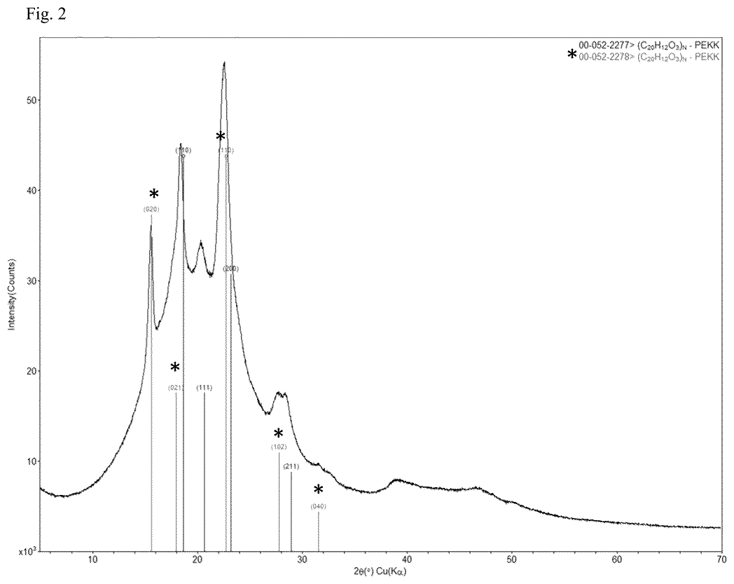

FIG. 3 is a photograph of a sheet of PEKK (T:I=70:30, 3 mm thickness) in accordance with the invention after thermoforming.

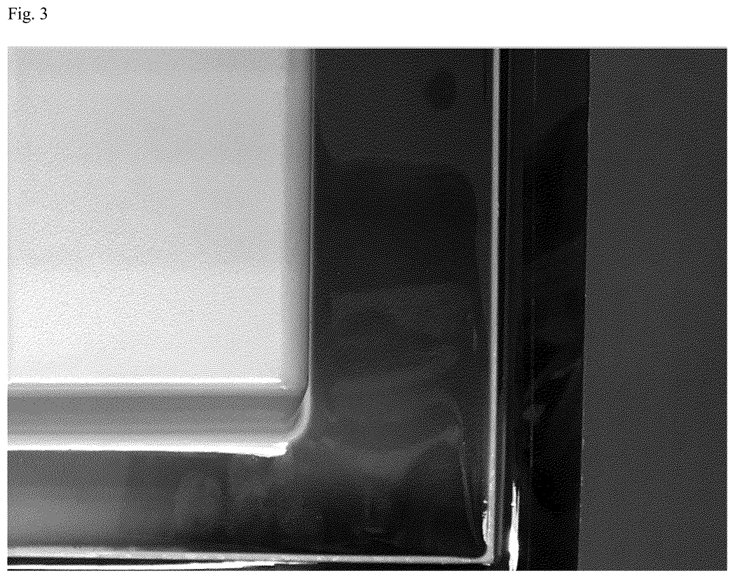

### DETAILED DESCRIPTION OF EMBODIMENTS OF THE INVENTION

As used herein, the term “article” may be used interchangeably with “part” or “object.” Exemplary articles of the present invention may comprise (or may comprise parts of), for example, speaker cones, speaker spiders, back-end/burn in integrated circuit (1C) test sockets, IC wafer carriers, IC wafer handling tools, IC handling trays, electronic packaging, blister packaging, 3D electronic circuits, bearings, backing plates, bushings, sensors, switches, electronic housings, tubing, cylinders, cups, containers, container lids, satellite panels, mirrors, pump parts {e.g., impellers, stators, housings), aerospace parts {e.g., cabinets, cabinet doors, sinks, control panels, toilets, passenger seat parts, including backs and pans), Compressed Natural Gas (CNG) or Compressed Liquefied Petroleum Gas (CLPG) composite tank forms, composite tooling forms, laminate protective cover films {e g. for FF/FDM/RFF tooling), and chemical storage containers. Exemplary articles of the present invention may comprise specialized parts of intricate geometry with potential applications including, but not limited to, aerospace, aircraft, oil and gas, electronics, building and construction, ducting, and high temperature containers, among others.

“Thermoforming” (encompassing “vacuum forming”), as used herein and in the art, comprises heating a sheet of material to a pliable temperature (e.g., in an oven) and forming the heated sheet onto a mold. Depending upon the thermoforming method selected, as will be explained subsequently in more detail), the mold may be relatively cold or relatively warm. For example, the mold may be at about room temperature, but in other embodiments may be at a temperature higher than room temperature such as a temperature up to the glass transition temperature of the polymer contained in the sheet to be thermoformed. The heated sheet may be stretched onto or over the mold using a vacuum and may cool thereon resulting in a molded article. Traditional thermoforming processes involve heating (e.g., in an oven) a sheet of material, such as a plastic sheet, to a high temperature, such as a temperature above the glass transition temperature of the material and placing the heated sheet in contact with a cold (e.g., room temperature) mold to form a desired shape. The sheet may be stretched into or onto a mold using, for instance, a vacuum. When sheets of pseudo-amorphous materials are subjected to such traditional thermoforming processes, the thermoformed part is rapidly cooled on the mold, thus taking the form of the mold. The rapidly cooled thermoformed part retains the properties of the pseudo-amorphous sheet subjected to thermoforming.

As used herein, the term “sheet” refers to a three dimensional article that is typically flat or substantially planar and has a thickness that is significantly less than the length and width of the article (unlike a pellet, tablet or cylinder). For example, a sheet may have a thickness that is less than 10% or less than 5% than both its length and width. A sheet is differentiated from a film by having a greater thickness; a sheet has a thickness of 500 microns or more, whereas a film has a thickness of less than 500 microns. The sheet may be adhered to a substrate or completely independent therefrom. The sheet may be non-porous, porous, microporous, etc., depending on the application and use. The thickness of the sheet may be measured, for example, using a standard micrometer.

As used herein, the term “pseudo-amorphous” polymers refers to polymers having from 0 weight percent crystallinity to 5 weight percent crystallinity as determined by X-ray diffraction. The term “pseudo-amorphous” thus includes both completely non-crystalline polymers (0 weight percent crystallinity, which may also be referred to as amorphous polymers) as well as polymers containing a limited degree of crystallinity (up to 5 wt %). For example, pseudo-amorphous polymers as discussed herein may be below five weight percent crystallinity, preferably below three weight percent crystallinity, or below two weight percent crystallinity. As used herein, the term “semi-crystalline” polymer refers to a polymer having more than five weight percent crystallinity as determined by X-ray diffraction. Semi-crystalline polymers as discussed herein may have at least six weight percent crystallinity or at least seven weight percent crystallinity as determined by X-ray diffraction.

As used herein, the term “about” also includes the precise value specified. For example, the range “about X to about Y” is understood to also include the range of “X to Y”. Further, any range that is stated is understood to also include its end points (e.g., “X to Y” includes the values of both X and Y).

As used herein, each compound may be discussed interchangeably with respect to its chemical formula, chemical name, abbreviation, etc. For example, PAEK may be used interchangeably with polyaryletherketone and PEKK may be used interchangeably with polyetherketoneketone. Additionally, each compound described herein, unless designated otherwise, includes homopolymers and copolymers. The term “copolymers” is meant to include polymers containing two or more different monomers and can include, for example, polymers containing two, three or four different repeating monomer units.

As used herein and in the claims, the terms “comprising” and “including” are inclusive or open-ended and do not exclude additional unrecited elements, compositional components, or method steps. Accordingly, the terms “comprising” and “including” encompass the more restrictive terms “consisting essentially of” and “consisting of.”

The term polyaryletherketone (“PAEK”) is intended to encompass all homopolymers and copolymers (including, e.g., terpolymers) and the like. In one embodiment, the polyaryletherketone is selected from the group consisting of polyetherketoneketones (PEKKs), polyetheretherketones (PEEKs), polyetherketones (PEKs), polyetherketoneetherketoneketones (PEKEKKs), and mixtures thereof. The at least one polyaryletherketone may optionally include more than one polyaryletherketone. In embodiments, the “at least one polymer” may comprise, consist essentially of, or consist of at least one PAEK, in particular at least one PEEK.

As previously mentioned, the present inventors have discovered that the melt viscosity of the polymer or combination of polymers used to fabricate a thermoformable sheet is an important variable in being able to successfully obtain a sheet that is thick (at least about 1000 microns in thickness) and that contains polymer which is in a pseudo-amorphous state (i.e., not semi-crystalline). In particular, it has been found that the polyaryletherketone (PAEK) or combination of polymers comprising at least one PAEK should have a viscosity at 360° C. of at least about 600 Pa s at 100 s⁻¹ as measured by parallel plate rheometer. Viscosity may be measured using ASTM D4440-15. If the viscosity at 360° C. is less than about 600 Pa·s at 100 s⁻¹ as measured by parallel plate rheometer, the melt strength of the polymer will likely be insufficient to permit the extrusion of a thick sheet (≥1000 microns) having a desirable substantially uniform thickness (i.e., the thickness of the extruded sheet will likely be inconsistent). Preferably, the polyaryletherketone (PAEK) or combination of polymers comprising at least one PAEK has a viscosity at 360° C. of at least about 700 Pa·s at 100 s⁻¹ as measured by parallel plate rheometer.

More preferably, the polyaryletherketone (PAEK) or combination of polymers comprising at least one PAEK has a viscosity at 360° C. of at least about 800 Pa·s at 100 s⁻¹ as measured by parallel plate rheometer. According to certain embodiments, the viscosity at 360° C. of the PAEK or combination of polymers comprising at least one PAEK does not exceed about 5000 Pa·s at 100 s⁻¹ as measured by parallel plate rheometer.

In an exemplary embodiment, the polyaryl ketone comprises, consists essentially of, or consists of polyetherketoneketone (PEKK). Polyetherketoneketones suitable for use in the present invention may comprise or consist essentially of or consist of repeating units represented by the following formulas I and II:

-A-C(=0)-B—C(=0) I

-A-C(=0)-D-C(=0)- II

where A is a ρ,ρ′-Ph-O-Ph-group, Ph is a phenylene radical, B is p-phenylene, and D is m-phenylene. The Formula I:Formula II (T:I) isomer ratio in the polyetherketoneketone can range from 100:0 to 0:100, but in various embodiments of the invention may be from 50:50 to 90:10, or from 65:35 to 75:25, or from 68:32 to 72:28, or about 70:30, or 70:30. The isomer ratio may be easily varied as may be desired to achieve a certain set of properties, e.g., by varying the relative amounts of the different monomers used to prepare the polyetherketoneketone. Generally speaking, a polyetherketoneketone having a relatively high Formula I:Formula II ratio will have a faster crystallization rate as compared to a polyetherketoneketone having a lower Formula I:Formula II ratio. As is known in the art, it is possible to prepare specimens comprised of a high T:I ratio PEKK which are pseudo-amorphous (i.e., the PEKK is in a pseudo-amorphous state, exhibiting not more than 5 wt % crystallinity) that nonetheless can be transformed into specimens which are semi-crystalline in character, through certain thermal treatments or processing of the specimens.

Thus, the TI ratio may be adjusted so as to control, among other parameters, the speed of crystallization in the PEKK. Generally speaking, a lower T:I ratio will provide a slower crystallization rate in an extruded sheet comprised of PEKK and thus a longer processing window. Conversely, a higher T:I ratio will provide a more rapid rate of crystallization and therefore a shorter processing window. In one embodiment, a polyetherketoneketone having a T:I isomer ratio of from about 50:50 to about 90:10 may be employed.

For example, the chemical structure for a polyetherketoneketone repeating unit with all para-phenylene linkages [PEKK(T)] may be represented by the following formula III:

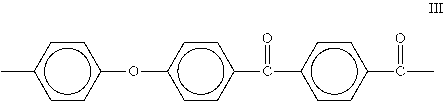

The chemical structure for a polyetherketoneketone repeating unit with one meta-phenylene linkage in the backbone [PEKK(I)] may be represented by the following formula IV:

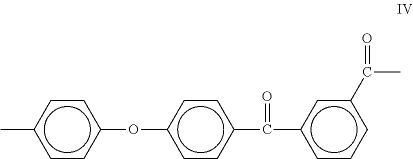

The chemical structure for a polyetherketoneketone repeating unit with perfectly alternating T and I isomers, e.g., a homopolymer having 50% of both T and I isomers [PEKK (T/I), i.e., PEKK having a T:I ratio of 50:50] may be represented by the following formula V:

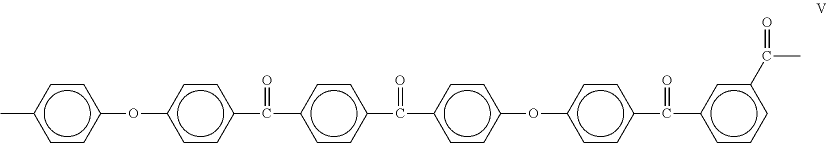

The polyaryletherketones may be prepared by any suitable method, with many such methods being and well known in the art. For example, a polyaryletherketone may be formed by heating a substantially equimolar mixture of at least one bisphenol and at least one dihalobenzoid compound or at least one halophenol compound. As another example, a polyaryletherketone may be formed by contacting at least one aromatic acid chloride and at least one aromatic ether in the presence of a Lewis acid. The polymer may be pseudo-amorphous (including amorphous) or semi-crystalline, which can be controlled through synthesis and processing of the polymer. The polymer(s) implemented in embodiments disclosed herein are preferably pseudo-amorphous (including amorphous), Additionally, the polymer(s) may also be of any suitable molecular weight (provided the minimum melt viscosity requirement is met) and may be functionalized or sulfonated, if desired. In one embodiment, the polymer(s) undergo sulfonation or any example of surface modification known to one skilled in the art.

Suitable polyetherketoneketones (PEKKs) are available from several commercial sources under various brand names. For example, polyetherketoneketones are sold under the brand name KEPSTAN® by Arkema Inc. A number of different polyetherketoneketone polymers are manufactured and supplied by Arkemna Inc.

The pseudo-amorphous polymers used in embodiments disclosed herein may include other polymers, in addition to one or more polyaryletherketone. In one embodiment, the other polymers share similar melting points, melt stabilities, etc. and are compatible by exhibiting complete or partial miscibility with one another. In particular, other polymers exhibiting mechanical compatibility with the polyaryletherketone(s) may be added to the composition. It is also envisioned, however, that the polymers need not be compatible with the polyaryletherketone(s). The other polymers may include, for example, polyamides (such as polyamide 11 and polyamide 12 commercially available from Arkema tinder the name Rilsan®, poly(hexamethylene adipamide) or poly(8-caproamide)); fluorinated polymers (such as PVDF, PTFE and FEP); polyimides (such as polyetherimide (PEI), thermoplastic polyimide (TPI), and polybenzimidazole (PBI)); polysulfones/sulfides (such as polyphenylene sulfide (PPS), polyphenylene sulfone (PPSO2), polyethersulfone (PES), and polyphenyl sulfone (PPSU)); poly(aryl ethers); and polyacrylonitrile (PAN). In one embodiment, the other polymers include polyamide polymers and copolymers, polyimide polymers and copolymers, etc. Polyamide polymers may be particularly suitable in high temperature applications. The additional polymers may be blended with the polyaryletherketone by conventional methods.

The pseudo-amorphous polymers used in embodiments disclosed herein may also include additional component(s), such as filler(s) or additive(s), to achieve specific properties desirable in particular applications, such as core-shell impact modifiers; fillers or reinforcing agents, such as glass fibers, carbon fibers and the like; plasticizers; pigments or dyes; thermal stabilizers; ultraviolet light stabilizers or absorbers; antioxidants; processing aids or lubricants; flame retardant synergists, such as Sb₂O₃, zinc borate, and the like; or mixtures thereof. These components may optionally be present, for example, in an amount of about 0.05 weight percent to about 70 weight percent based on the total weight of the composition from which a polymer sheet or article (used to form a semi-crystalline article of disclosed embodiments, wherein the article is comprised of a polymer, in particular a PAEK, in a semi-crystalline state) is formed. Preferably, any such filler or additive is non-nucleating.

Suitable fillers may include fibers, powders, flakes, etc. Reinforcing fillers may be employed. For example, suitable fillers may include at least one of carbon nanotubes, carbon fibers, glass fibers, polyamide fibers, hydroxyapatite, aluminum oxides, titanium oxides, aluminum nitride, silica, alumina, barium sulfates, graphene, graphite, etc. The size and shape of the fillers are also not particularly limited. Such fillers may be optionally present in an amount from about 0.1 weight percent to about 70 weight percent, or from about 10 weight percent to about 70 weight percent (based on a total weight of the composition from which a polymer sheet or article used in disclosed embodiments is formed).

A resin composition comprised of one or more polyaryletherketones, possibly in combination with one or more other polymers, fillers and/or other additives are described above, may be formed into sheets using the following general procedures, which may be adapted or modified to best suit the particular resin composition being processed and the characteristics desired in the thermoformable sheet thereby obtained (e.g., thickness, degree of crystallinity).

The sheets of the present invention are relatively thick (i.e., the sheets have a thickness of at least about 500 microns, e.g., from about 1000 microns to about 10,000 microns, preferably from about 1000 to about 3500 microns) and contain at least one polyaryletherketone, such as a polyetherketoneketone, which is in a pseudo-amorphous state. Generally speaking, the thickness of such sheets is substantially uniform. The length and width of the sheets may be varied as may be desired for particular end-use applications, depending upon the dimensions of the molded articles, including semi-crystalline molded articles, that are to be prepared by thermoforming the pseudo-amorphous sheets.

Thermoformable sheets in accordance with the present invention are preferably made by melt extrusion. Conventional single screw or twin screw extruders, sheeting dies, and take-up devices designed for extrusion of thermoplastic resins into sheets may be employed. The extrusion temperature will depend on the polymer melt temperature (which, in the case of a PEKK, is influenced by its T:I ratio) as well as on the molecular weight or melt viscosity. For example, when the T:I isomer ratio in a PEKK is 70:30 or 50:50, the preferred extrusion temperature is between about 360° C. and about 380° C. As a further example, when the T:I isomer ratio is 60:40, the preferred extrusion temperature is between about 325° C. and about 360° C. In general, extrusion temperatures from about 5° C. to about 70° C. or from about 10° C. to about 50° C. above the melting point of the polyaryletherketone are satisfactory. Extrusion temperatures near the lower ends of the above ranges are preferred, and preferably should be less than 400° C. Lower extrusion temperatures may be preferred in order for the resin composition being extruded to have a viscosity which facilitates the extrusion of a sheet of uniform thickness and acceptable structural integrity and to reduce the crystallization window time. Also, as sheet thickness is increased, it is usually preferable to operate at the lower end of the available temperature range. Higher extrusion temperatures are possible, but can lead to an undesirably longer time in the crystallization stage of a thermoforming process.

The extruded sheet comprised of polyaryletherketone is conveyed from the die directly over polished metal or textured roll(s), commonly termed “chill rolls” because the surface temperature of these rolls is maintained at a level below the melt temperature of the polymer. A stream of air or other gas may also be directed at the extruded sheet in order to facilitate cooling. The rate at which the sheet is cooled (termed the quench rate) and solidified is an important aspect in achieving a pseudo-amorphous sheet structure. The quench rate is largely determined by the temperature of the chill rolls, sheet thickness and line speed and must be sufficiently rapid for the desired pseudo-amorphous character in the sheet to be realized, without being so rapid that a warped, wrinkled or curled sheet results. Typically, the extruded sheet is desirably cooled as quickly as possible to about room temperature, while avoiding any warping, wrinkling or curling of the sheet. It is believed that the dependence of physical properties and thermoformability on quench rate is related to inherent polymer properties, such as crystallization rate and the rate of solidification of the polymer as it cools through its glass transition temperature. Following extrusion and quenching, the extruded sheet may be cut or divided to provide individual sheets having dimensions suitable for use in a particular desired thermoforming operation.

According to certain embodiments, sheets in accordance with the invention may be reheated to a state where the sheet has been softened (without significant crystallization), then formed into an article, with the polymer (e.g., PAEK) present in the formed article then being crystallized (by heating to a higher temperature where crystallization takes place, for example).

Sheets in accordance with the present invention may be employed in any type of molding process to produce a finished molded article, but are particularly well-suited for use in thermoforming. As will be described in more detail subsequently, such sheets are especially useful in the production of semi-crystalline molded articles in which the polymer component of the sheets has been converted from a pseudo-amorphous state to a semi-crystalline state.

Shaped articles can be prepared from sheets in accordance with the invention using a thermoforming process. Thermoforming is a process in which a thermoplastic sheet is heated to its processing temperature and, using mechanical methods or differential pressure created by vacuum and/or pressure, is brought into contact with a mold surface and cooled while held to the contours of the mold until it retains the shape of the mold. The sheets of the present invention are particularly useful in such a process, as the thermoformed semi-crystalline molded articles thereby obtained can have dimensions very similar to the dimensions of the mold used to create such articles. For example, the semi-crystalline molded article may exhibit less than about 5%, less than about 4%, less than about 3%, less than about 2%, or even less than about 1% dimensional change compared to the mold. Thus, the sheets of the present invention make possible the production of thermoformed articles which exhibit less deformation, less shrinkage and/or better dimensional tolerance, as compared to other PAEK-based sheets known in the art. The sheet prior to thermoforming may be transparent. As a result of the sheet being thermoformed and the crystallinity of the polyaryletherketone being increased, the molded article obtained from the initially transparent sheet may be opaque.

The sheets of this invention can be readily thermoformed by standard methods using standard equipment, such as by vacuum, pressure, mechanical or twin sheet thermoforming. Optimum thermoforming conditions will vary depending upon the specific types of thermoforming machine and mold used, but such conditions can be readily established by techniques normally and conventionally used in the art. Where the polyaryletherketone is a polyetherketoneketone (PEKK), for example, the thermoforming temperature range for the sheets (i.e., the temperature of the sheet during thermoforming) is typically within the range of from 160° C. to 300° C. However, a sheet temperature of from about 160° C. to about 220° C. is generally preferred, since a sheet temperature of greater than 220° C. may result in a crystallization rate that is too rapid.

The time required to heat the sheet to the thermoforming temperature range prior to the forming event can be a significant variable in the process of thermoforming the sheets of this invention. Generally speaking, in certain types of thermoforming procedures it will be desirable to minimize the preheat time while still maintaining a uniform heat distribution in the sheet, in order to achieve uniform draw in the forming step. Since residence time will depend on process variables, such as sheet dimensions (especially sheet thickness), thermal characteristics of the particular oven and the forming temperature range desired, the ideal forming conditions must be determined by experimentation but can be readily established by a person skilled in the plastics thermoforming art. For sheets based on PEKK, the residence time will be typically be short, for example, 1 to 5 minutes.

Although either radiant or convection ovens are suitable for preheating, radiant heaters are generally preferred because of their efficiency. Radiant heater surface temperatures normally are maintained between 500° C. and 1100° C., preferably between 600° C. and 900° C. Excessively high sheet temperatures or oven residence time can result in poor forming characteristics of the pseudo-amorphous polyaryletherketone-containing sheet, such as inadequate draw or lack of mold definition and brittleness in the formed articles.

Thermoforming of sheets can be achieved by vacuum forming, with or without pressure or plug assist. Vacuum levels typically are at least 68 kPa. Forming pressures may range from atmospheric to 690 kPa. Mold temperatures may range, for example, from ambient to 290° C. According to certain embodiments of the invention, a mold temperature of from about 160° C. to about 280° C. may be employed. Elevated mold temperatures and/or additional pressure generally minimize internal stresses and provide better detail and material distribution resulting in a more uniform part.

Sheets in accordance with the present invention are especially suitable for use in the thermoforming procedures described in WO 2018/232119, the entire disclosure of which is incorporated herein by reference for all purposes. The procedures described in the aforementioned published patent application make possible the production of a thermoformed part that is semi-crystalline from a pseudo-amorphous polymer sheet, such as a sheet in accordance with the present invention. According to an embodiment of the present invention, a method of producing a molded part comprises thermoforming a sheet in accordance with the invention under conditions effective to produce a semi-crystalline molded article.

According to an embodiment, a method of manufacturing a semi-crystalline article from a sheet comprising at least one pseudo-amorphous polymer comprises a softening step in which the sheet is heated to a temperature above the glass transition temperature of the pseudo-amorphous polymer without substantive crystallization of the pseudo-amorphous polymer to soften the pseudo-amorphous polymer and a crystallization step wherein the at least one pseudo-amorphous polymer is heated to a temperature above the glass transition temperature of the pseudo-amorphous polymer and below the melting temperature of the pseudo-amorphous polymer for a time sufficient to allow the pseudo-amorphous polymer to crystallize (thereby forming semi-crystalline polymer). During the softening step, it is conceivable that some crystallization may take place; however, preferably if crystallization occurs at the softening step, such crystallization is less than about 10 wt %, less than about 5 wt %, less than about 2 wt %, less than about 0.5 wt %, less than about 0.1 wt %, or less than about 0.01 wt %. In some embodiments, the sheet comprising pseudo-amorphous polymer may be placed on a mold during the softening step. In some embodiments, the sheet comprising pseudo-amorphous polymer may be placed on a mold during the crystallization step before at least some of the crystallization takes place. A semi-crystalline molded article may be formed on the mold. The semi-crystalline molded article may be opaque; however, in certain embodiments the semi-crystalline article may be almost translucent or translucent.

The sheet may be maintained on the mold during the crystallization step for a time period in the range of from a few seconds to a few minutes, depending upon factors such as the thickness of the sheet. For example, if the sheet is about 1000 microns to about 2000 microns thick, the sheet may be maintained on the mold for a time of from about 30 seconds to about 1 minute. As another example, if the sheet is about 3000 microns thick, the sheet may be maintained on the mold for 4 minutes or more (up to about 6 to 7 minutes, for example).

In some embodiments, the mold may be heated on at least one side. In some embodiments, the sheet comprised of pseudo-amorphous polymer may be heated during a softening step to a temperature above the glass transition temperature (Tg) of the pseudo-amorphous polymer, for example a temperature within the range of from about 160° C. to about 220° C. or from about 190° C. to about 215° C., during the softening step. During the softening step, in some embodiments, the temperature of the sheet may be measured using a non-contact method, such as by using a non-contact infrared gun. In some embodiments, the mold and sheet comprised of pseudo-amorphous polymer may be heated to a temperature in the range of from about 210° C. to about 280° C., from about 230° C. to about 260° C., or about 250° C. during the crystallization step. In some embodiments, the temperature of the sheet comprised of pseudo-amorphous polymer may be measured by using a probe within the mold.

In some embodiments, the sheet comprised of pseudo-amorphous polymer is placed on the mold during or immediately prior to the crystallization step. In some embodiments, the sheet comprised of pseudo-amorphous polymer may be placed onto the mold using a vacuum subsequent to the softening step. In other embodiments, the sheet comprised of pseudo-amorphous polymer is maintained on the mold during both the softening step and the crystallization step.

In some embodiments, the molded article produced may demonstrate at least 1 wt % higher crystallinity (in absolute terms), at least 5 wt % higher crystallinity, at least 10 wt % higher crystallinity, at least 15 wt % higher crystallinity, at least 20 wt % higher crystallinity, or at least 25 wt % higher crystallinity, as compared to the sheet comprised of pseudo-amorphous polymer, or a crystallinity that is about 10 to about 30 wt % or about 10 to about 25 wt % higher than the crystallinity of the sheet comprised of pseudo-amorphous polymer. For example, a molded article having 25 wt % crystallinity may be produced from a sheet comprised of PEKK in pseudo-amorphous form which has a crystallinity of 2 wt % (a 23 wt % increase in crystallinity, i.e., the molded article has a 23 wt % higher crystallinity than the starting pseudo-amorphous PEKK-based sheet.

Illustrative aspects of the present invention may be summarized as follows:

Aspect 1: A sheet comprised of a polymer, wherein the sheet has a thickness of from about 1000 microns to about 10,000 microns (or 1000 microns to 10,000 microns) and the polymer is a polyaryletherketone (PAEK) in a pseudo-amorphous state which has a viscosity at 360° C. of at least about 400 Pa·s (or at least 400 Pa·s) at 100 s⁻¹ as measured by parallel plate rheometer.

Aspect 2: The sheet of Aspect 1, wherein the polymer has a viscosity at 360° C. of at least about 600 Pa·s (or at least 600 Pa·s) at 100 s⁻¹ as measured by parallel plate rheometer.

Aspect 3: The sheet of Aspect 1, wherein the polymer has a viscosity at 360° C. of at least about 800 Pa·s (or at least 800 Pa·s) at 100 s⁻¹ as measured by parallel plate rheometer.

Aspect 4: The sheet of Aspect 1, wherein the polymer has a viscosity at 360° C. of not more than about 5000 Pa·s (or not more than 5000 Pa·s) at 100 s⁻¹ as measured by parallel plate rheometer.

Aspect 5: The sheet of any of Aspects 1 to 4, wherein the polyaryletherketone (PAEK) is selected from the group consisting of polyetherketoneketone (PEKK), polyetherketone (PEK), polyetherketoneetherketoneketone (PEKEKK) and combinations thereof.

Aspect 6: The sheet of any of Aspects 1 to 5, wherein the polyaryletherketone (PAEK) is polyetherketoneketone (PEKK).

Aspect 7: The sheet of Aspect 6, wherein the polyetherketoneketone (PEKK) has a T:I isomer ratio of from about 50:50 to about 90:10 (or from 50:50 to 90:10).

Aspect 8: The sheet of Aspect 6, wherein the polyetherketoneketone (PEKK) has a T:I isomer ratio of from about 65:35 to about 75:25 (or from 65:35 to 75:25).

Aspect 9: The sheet of Aspect 6, wherein the polyetherketoneketone (PEKK) has a T:I isomer ratio of from about 68:32 to about 72:28 (or from 68:32 to 72:28).

Aspect 10: The sheet of Aspect 6, wherein the polyetherketoneketone (PEKK) has a T:I isomer ratio of about 70:30 (or 70:30).

Aspect 11: The sheet of any of Aspects 1 to 10, wherein the sheet is additionally comprised of one or more non-nucleating fillers.

Aspect 12: The sheet of any of Aspects 1 to 11, wherein the sheet is additionally comprised of one or more non-nucleating fillers selected from the group consisting of reinforcement fibers, pigments, thermal stabilizers, antioxidants, glass spheres, silica, and talc.

Aspect 13: The sheet of any of Aspects 1 to 12, wherein the sheet is transparent.

Aspect 14: A method of manufacturing a semi-crystalline article, wherein the method comprises thermoforming a sheet in accordance with any of Aspects 1 to 13 using a mold.

Aspect 15: A method of manufacturing a semi-crystalline article, comprising:
a) as a softening step, heating a sheet in accordance with any of Aspects 1 to 13 to a temperature above the glass transition temperature of the polymer to soften the polymer;
b) as a crystallization step, heating the sheet to a temperature above the glass transition temperature of the polymer and below the melting temperature of the polymer for a time sufficient to allow the polymer to crystallize;
c) placing the sheet on a mold during either the softening step or the crystallization step before crystallization takes place; and
d) forming a semi-crystalline molded article.

Aspect 16: A semi-crystalline article obtained in accordance with Aspect 14 or Aspect 15, wherein the semi-crystalline article exhibits less than about 3% (or less than 3%) dimensional change compared to the mold.

Aspect 17: A method of making a sheet in accordance with any of Aspects 1 to 13, wherein the method comprises:
a) heating a resin composition comprised of the polymer to a suitable processing temperature above the melting point of the polymer to provide a molten resin composition;
b) forming the molten resin composition into a sheet; and
c) quenching the sheet at a rate effective to obtain the polymer in a pseudo-amorphous state.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1

Pseudo-amorphous 3 mm thick sheet was produced from a PEKK copolymer having a T:I ratio of 70:30 and a viscosity at 360° C. of 850 Pa·s at 100 s⁻¹ as measured by parallel plate rheometer using a single screw extruder and two chill roll system. The extrusion temperature was set at 375° C., and the line speed was 0.5 m/min; cooling was only provided by the chill rolls and ambient air.

The sheets were thermoformed using a shuttle type thermoformer, equipped with a female vacuum forming mold. The sheet was placed in the heating oven, and extracted when the surface temperature of the sheet reached 210° C. The sheet was then quickly placed on the mold, which was heated to 250° C. with electric cartridge heaters. After vacuum forming, the part was allowed to contact the mold for 4 minutes before ejecting so that crystallization could occur. The resulting object was opaque and crystalline in the areas where it had contacted the mold and transparent where it was not in contact with the mold. Wide angle X ray diffraction was performed on the sheet before and after thermoforming, indicating that crystallinity had increased from <1 wt % before thermoforming to about 29 wt % after thermoforming.

### WAXD Conditions

WAXD diffraction patterns of polymeric sheets were obtained using the following procedure. X-ray diffraction experiments were conducted on a Rigaku SmartLab diffraction pattern. All data acquisitions were done in 1D mode.

### Experimental Acquisition Conditions

WAXS: 1.0°-80.0° 2θ range. Steps=0.03°. Scan speed=1.0°/min.
IS=1.0 mm; RS1=3.0 mm; RS2=3.1 mm. Cross beam optics.

### Example 2

In this example, a computational study was conducted to measure the crystallinity of extruded PEKK sheets with T:I ratios between 68:32 and 74:26 and thicknesses between 1 mm and 10 mm using a finite-element model. The model specifies the density, thermal conductivity, and heat capacity of each PEKK grade, an extruder temperature of 380° C., an extrusion rate of 10 cm/min, convective cooling with ambient air at 25° C. using a heat transfer coefficient of 65 W/m²/K (assuming some air circulation), and sheet thicknesses between 1 mm and 10 mm. The model uses a crystallization rate based on the isothermal and non-isothermal crystallization equations in Choupin, “Mechanical performances of PEKK thermoplastic composites linked to their processing parameters” (2017), with parameters adjusted to match measured crystallinity half-times of each grade. Table 1 lists the estimated maximum thicknesses of extruded PEKK sheets by grade (T:I ratio) needed to maintain a crystallinity of 5 wt % or less in any portion of the sheet.

TABLE 1
Estimated maximum thickness of extruded PEKK sheets to
maintain a pseudo-amorphous sheet (“pseudo-amorphous”
signifies a crystallinity of not more than 5 wt %)

| Grade | Maximum thickness |
|---|---|
| (T:I) | (mm) |
| 68:32 | >10 |
| 70:30 | 6 |
| 72:28 | 3.75 |
| 74:26 | 3.25 |

### Comparative Example 1

Pseudo-amorphous 3 mm thick sheet was produced from a PEKK copolymer having a T:I ratio of 70:30 and a viscosity at 360° C. of 850 Pa·s at 100 s⁻¹ as measured by parallel plate rheometer using a single screw extruder and two chill roll system. The extrusion temperature was set at 375° C., and the line speed was 0.5 m/min; cooling was only provided by the chill rolls and ambient air.

The sheets were thermoformed using a shuttle type thermoformer, equipped with a female vacuum forming mold. The sheet was placed in the heating oven, and extracted when the surface temperature of the sheet reached 210° C. The sheet was then quickly placed on the mold, which was only heated to 120° C. with electric cartridge heaters. After vacuum forming, the part was allowed to contact the mold for 4 minutes before ejecting. The resulting object was transparent. Wide angle X ray diffraction was performed on the sheet before and after thermoforming, indicating that crystallinity had remained <1 wt % before thermoforming and after thermoforming.

1. A semi-crystalline molded article consisting of a polymer sheet and, optionally, one or more non-nucleating additives,
wherein the sheet has a thickness of from 1000 microns to 10,000 microns and is formed from a polyaryletherketone (PAEK) polymer in a pseudo-amorphous state which has a viscosity at 360° C. of at least 400 Pa·s at 100 s⁻¹ as measured by parallel plate rheometer.

2. The semi-crystalline molded article of claim 1, wherein the polymer has a viscosity at 360° C. of at least 600 Pa·s at 100 s⁻¹ as measured by parallel plate rheometer.

3. The semi-crystalline molded article of claim 1, wherein the polymer has a viscosity at 360° C. of at least 800 Pa·s at 100 s⁻¹ as measured by parallel plate rheometer.

4. The semi-crystalline molded article of claim 1, wherein the polymer has a viscosity at 360° C. of not more than 5000 Pa·s at 100 s⁻¹ as measured by parallel plate rheometer.

5. The semi-crystalline molded article of claim 1, wherein the polyaryletherketone (PAEK) is selected from the group consisting of polyetherketoneketone (PEKK), polyetherketone (PEK), polyetherketoneetherketoneketone (PEKEKK) and combinations thereof.

6. The semi-crystalline molded article of claim 1, wherein the polyaryletherketone (PAEK) is polyetherketoneketone (PEKK).

7. The semi-crystalline molded article of claim 6, wherein the polyetherketoneketone (PEKK) has a T:I isomer ratio of from 50:50 to 90:10.

8. The semi-crystalline molded article of claim 6, wherein the polyetherketoneketone (PEKK) has a T:I isomer ratio of from 65:35 to 75:25.

9. The semi-crystalline molded article of claim 6, wherein the polyetherketoneketone (PEKK) has a T:I isomer ratio of from 68:32 to 72:28.

10. The semi-crystalline molded article of claim 6, wherein the polyetherketoneketone (PEKK) has a T:I isomer ratio of about 70:30.

11. The semi-crystalline molded article of claim 1, wherein the sheet contains of one or more non-nucleating additives.

12. The semi-crystalline molded article of claim 1, wherein the one or more non-nucleating additives are selected from the group consisting of fillers, reinforcement fibers, pigments, thermal stabilizers, antioxidants, glass spheres, silica, and talc.

13. The semi-crystalline molded article of claim 1, wherein the sheet is transparent.

14. A method of manufacturing the semi-crystalline article of claim 1, wherein the method comprises thermoforming the polymer sheet in a mold.

15. A method of manufacturing the semi-crystalline article of claim 1, the method comprising:
a) as a softening step, heating the polymer sheet to a temperature above the glass transition temperature of the PAEK polymer to soften the PAEK polymer;
b) as a crystallization step, heating the polymer sheet to a temperature above the glass transition temperature of the PAEK polymer and below the melting temperature of the PAEK polymer for a time sufficient to allow the PAEK polymer to crystallize;
c) placing the polymer sheet on a mold during either the softening step or the crystallization step before crystallization takes place; and
d) forming the semi-crystalline molded article.

16. The semi-crystalline article of claim 1, wherein the semi-crystalline article exhibits less than 3% dimensional change compared to the mold.

17. A method of making the polymer sheet in accordance with claim 1, wherein the method comprises:
a) heating a resin composition comprised of the PAEK polymer to a suitable processing temperature above the melting point of the PAEK polymer to provide a molten resin composition;
b) forming the molten resin composition into a sheet; and
c) quenching the sheet at a rate effective to obtain the PAEK polymer in a pseudo-amorphous state.

18. A method of forming a semi-crystalline article, wherein the method comprises:
selecting a polyaryletherketone (PAEK) in a pseudo-amorphous state which has a viscosity at 360° C. of at least 400 Pa·s at 100 s⁻¹ as measured by parallel plate rheometer;
extruding the PAEK into a polymer sheet with a thickness of from 1,000 microns to 10,000 microns;
thermoforming the PAEK polymer sheet into the semi-crystalline article, wherein the thermoforming includes:
a) as a softening step, heating the PAEK polymer sheet to a temperature above the glass transition temperature of the PAEK to soften the polymer sheet;
b) as a crystallization step, heating the PAEK polymer sheet to a temperature above the glass transition temperature of the PAEK and below the melting temperature of the PAEK for a time sufficient to allow the polymer sheet to crystallize;
c) placing the PAEK polymer sheet on a mold during either the softening step or the crystallization step before crystallization takes place; and
d) forming the semi-crystalline article,
wherein the crystallization step occurs at 210 to 280° C.
